(19) United States
(12) Patent Application Publication
(10) Pub. No.: US 2022/0297057 A1
(43) Pub. Date: Sep. 22, 2022

(54) FACILITY FOR TREATMENT BY ADSORBENTS

(71) Applicant: CMI EUROPE ENVIRONNEMENT, Aspach-Michelbach (FR)

(72) Inventors: Virginie Kreim, Wegsheid (FR); Philippe Geiger, Blotzheim (FR)

(21) Appl. No.: 17/636,371

(22) PCT Filed: Aug. 18, 2020
(86) PCT No.: PCT/EP2020/073118

§ 371 Date: Feb. 18, 2022

(30) Foreign Application Priority Data
Aug. 19, 2019 (FR) FR1909285

(51) Int. Cl. B01D 53/26; B01D 53/04

(52) U.S. Cl. CPC B01D 53/265; B01D 53/0438; B01D 2253/102; B01D 2257/80; B01D 2259/40001

(57) ABSTRACT

An installation for treating a gas stream includes: a vessel having an inlet for the gas stream for treatment so as to provide a treated gas stream; an outlet for the treated gas stream; and an adsorbent mass. The vessel is bounded by a double wall defining a peripheral enclosure that surrounds the vessel and that comprises an enclosure inlet and an enclosure outlet for the gas stream for treatment, the enclosure outlet being connected to the inlet of the vessel.

### CROSS-REFERENCE TO PRIOR APPLICATIONS

This application is a U.S. National Phase application under 35 U.S.C. § 371 of International Application No. PCT/EP2020/073118, filed on Aug. 18, 2020, and claims benefit to French Patent Application No. FR 1909285, filed on Aug. 19, 2019. The International Application was published in French on Feb. 25, 2021 as WO 2021/032748 under PCT Article 21(2).

### FIELD

The present invention relates to the field of treatment by means of a gas stream, e.g. for the purpose of removing molecules that are harmful (such as volatile organic compounds), corrosive, and/or malodorous (NH₃, H₂S, . . . ).

### BACKGROUND

Treatment installations are known that comprise a vessel having an inlet for a gas stream for treatment and an outlet for a treated gas stream, and that contain an adsorbent mass comprising activated carbon or other adsorbents (e.g. in pellet form).

It is known that humidity affects the effectiveness of activated carbon, such that a heater is provided upstream from the inlet to the vessel, which heater is sufficiently powerful to raise the temperature of the gas stream so as to bring the humidity level of the gas stream entering the vessel to a value that is compatible with the effectiveness desired for the treatment installation.

It also happens that the temperature difference between the inside and the outside of the enclosure gives rise to condensation inside the enclosure, which condensation is harmful for the effectiveness of activated carbon. However, the vessel is generally located outdoors where it is not sheltered from variations in the temperature of outside air.

### SUMMARY

In an embodiment, the present invention provides an installation for treating a gas stream, the installation comprising: a vessel having an inlet for the gas stream for treatment so as to provide a treated gas stream; an outlet for the treated gas stream; and an adsorbent mass, wherein the vessel is bounded by a double wall defining a peripheral enclosure that surrounds the vessel and that comprises an enclosure inlet and an enclosure outlet for the gas stream for treatment, the enclosure outlet being connected to the inlet of the vessel.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a diagrammatic view showing the principle on which an installation in accordance with the invention operates;

FIG. 2 is a diagrammatic plan view of the installation;

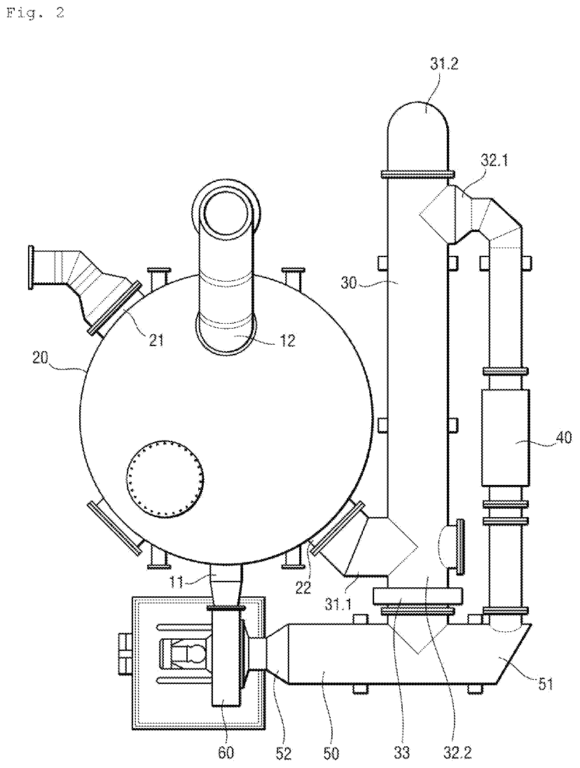

FIG. 3 is a diagrammatic perspective view, partially in section, showing the activated carbon vessel of the installation; and

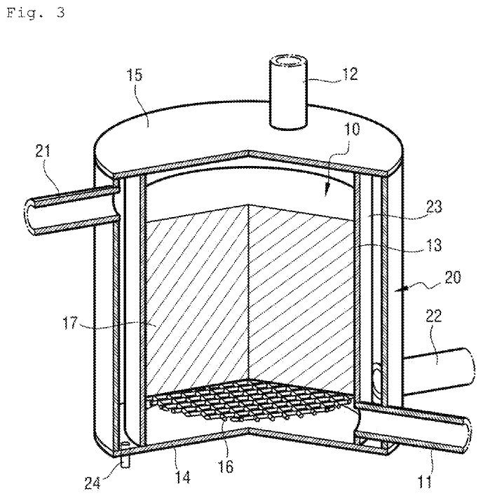

FIG. 4 is a plan view of the installation.

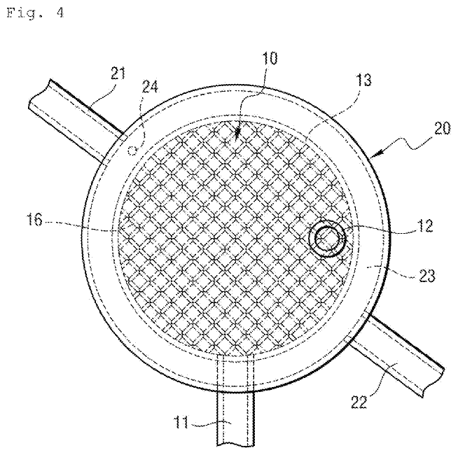

### DETAILED DESCRIPTION

In an embodiment, the present invention provides means for improving the effectiveness of such treatment installations when the gas stream for treatment is loaded with humidity.

To this end, according to an embodiment of the present invention, there is provided an installation for treating a gas stream, the installation comprising a vessel having an inlet for the gas stream for treatment and an outlet for the treated gas stream, and containing an adsorbent mass. The vessel is bounded by a double wall defining a peripheral enclosure that surrounds the vessel and that possesses an inlet and an outlet for the gas stream for treatment, the outlet of the peripheral enclosure being connected to the inlet of the vessel.

Thus, the double wall provides passive thermal insulation for the inside of the vessel relative to the outside. Also, the temperature of the gas stream for treatment flowing through the peripheral enclosure contributes to this thermal insulation relative to the outside. This makes it possible to avoid the risk of condensation in the vessel as a result of the gas stream cooling on contact with the wall of the vessel and to limit heating of the gas stream on entry into the vessel, which heating may be necessary to reduce the humidity level of the gas stream for treatment.

According to various optional characteristics of the invention, which may be used in combination or individually:

the outlet of the peripheral enclosure is connected to a heat exchanger that has an outlet connected to a droplet separator and that is subjected to a cooling stream having a temperature lower than the temperature of the gas stream for treatment entering the heat exchanger so as to cool the gas stream for treatment and load it with water;

a heater, arranged to desaturate the gas stream for treatment, is connected between the inlet of the vessel and the outlet of the peripheral enclosure;

the heater is adjusted to bring the gas stream for treatment entering the vessel to a temperature lower than the temperature of the gas stream at the inlet of the peripheral enclosure;

the installation includes a fan for forcing the gas stream for treatment to flow through the installation.

In a preferred embodiment, the above characteristics are combined with one another.

The installation of the invention is then particularly effective and inexpensive.

Advantageously, the heater comprises a first heat exchange circuit that is arranged beside the inlet of the vessel to heat the gas stream and that is connected to a second heat exchange circuit arranged beside the outlet of the peripheral enclosure in order to cool the gas stream for treatment.

Other characteristics and advantages of the invention appear on reading the following description of a particular and nonlimiting implementation of the invention.

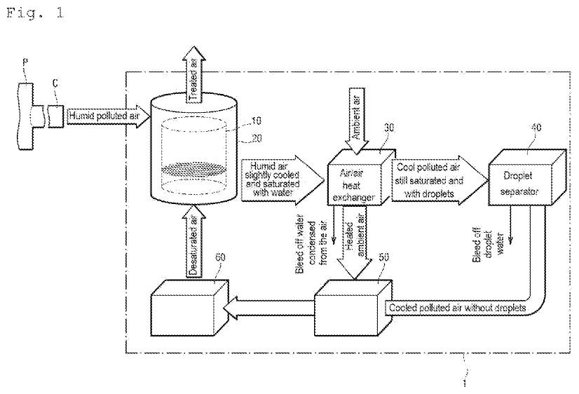

With reference to FIG. 1, the invention is described below in application to treating a gas stream delivered by an exhaust pipe C of an industrial production site P.

With reference also to the other figures, the installation of the invention for treating a gas stream is given overall reference 1 and comprises a vessel 10 having an inlet pipe 11 for the gas stream for treatment and an outlet pipe 12 for the treated gas stream. The inlet pipe 11 is provided with conventional connection means for connecting to another element for transporting the gas stream for treatment, and the outlet pipe 12 is provided with conventional connection means for connecting to an exhaust pipe, such as a chimney or a treatment device of identical or different type serving to perform additional treatment on the gas stream leaving the vessel 10.

The vessel 10 has a side wall 13, which is cylindrical in this example, a bottom wall 14, and a top wall 15, which walls together bound an inside volume of the vessel 10. The inlet pipe 11 opens out into the inside volume in the vicinity of the bottom wall 14, and the outlet pipe 12 opens out into the inside volume through the top wall 15.

A grid 16 extends horizontally in the inside volume of the vessel 10, above the outlet of the inlet pipe 11 of the vessel 10 and it carriers and an adsorbent mass 17, which in this example comprises activated carbon. The outlet pipe 12 opens out into the vessel 10 above the adsorbent mass 17.

The vessel 10 is surrounded by an outer shell 20 that, in this example, comprises a cylindrical wall extending coaxially around the side wall 13 so as to co-operate therewith to form a double wall defining an annular peripheral enclosure 23 that surrounds the vessel 10.

The outer shell 20 is provided with an inlet pipe 21 and with an outlet pipe 22 for the gas flow to be treated. In this example, the inlet pipe 21 and the outlet pipe 22 are diametrically opposite each other, the inlet pipe 21 opening out into the peripheral enclosure 23 in the vicinity of the top wall 15, and the outlet pipe 22 has one end opening out into the peripheral enclosure 23 in the vicinity of the bottom wall 14 and an opposite end opening out outside the peripheral enclosure 23 and of the vessel 10. The peripheral enclosure 23 has the inlet pipe 11 passing therethrough and it includes a purge orifice 24 for bleeding off the water generated by condensation on the inside surface of the outer shell 20.

The inlet pipe 21 is provided with means for connecting it to the pipe C.

The outlet pipe 22 of the outer shell 20 is connected to a heat exchanger 30 defining:

a first circuit having one end 31.1 connected to the outlet pipe 22 and one end 32.1 connected to an inlet of a droplet separator 40;

a second circuit having one end 31.2 connected to an outside air inlet and one end 32.2 connected to a valve 33.

The outside air constitutes a cooling stream at a temperature lower than the temperature of the gas stream for treatment entering the heat exchanger 30 so as to cool the gas stream for treatment and saturate its relative humidity and discharge water therefrom.

In conventional manner, the heat exchanger 30 has a purge orifice for bleeding off the water generated by condensation in the cooling stream.

The outlet from the droplet separator 40 is connected to a mixer 50 having one end 51 connected to the outlet of the droplet separator 40 and one end 52 connected to a centrifugal fan 60. The valve 33 has an outlet connected to the mixer 50 so as to be capable of inserting into the mixer 50 the stream of air that leaves the heat exchanger 30 and that has been heated in the heat exchanger 30 by the gas stream for treatment and that has a relative humidity level that is lower than the level in the gas stream for treatment.

The centrifugal fan 60 has an outlet connected to the inlet duct 11 and it is arranged to force the gas stream for treatment to flow through the vessel 10. Also, by increasing the pressure of the gas stream for treatment, it increases its temperature.

The mixer 50 and the fan 60 are arranged to desaturate the gas stream for treatment, i.e. to bring the humidity level of the gas stream for treatment to the maximum humidity level that is compatible with operation of the adsorbent mass 17.

Specifically, ambient air, as heated by the gas stream in the heat exchanger, and in which the relative humidity level has been lowered, is mixed with the gas stream for treatment in which the temperature has been lowered.

This mixing enables the relative humidity level of the gas stream to be lowered at the inlet 11 of the vessel 10. In certain circumstances, this can make it possible to omit a heater.

The fan 60 and the valve 33 are designed, and are adjusted when putting the installation into service, so that the gas stream for treatment on entry into the vessel 10 has a temperature that is lower by a predetermined quantity than the temperature of the gas stream for treatment on entry into the peripheral enclosure 23.

By way of example, FIG. 1 mentions temperatures and humidity levels that it is possible to have when using the installation of the invention:

in the inlet pipe 21, the gas stream for treatment has a temperature of 15° C. and a relative humidity level of 90%;

in the outlet pipe 22, the gas stream for treatment has a temperature of 13° C. and is saturated with water with a relative humidity level of 100%;

on entry into the heat exchanger 30, the cooling stream has a temperature of −5° C. and a relative humidity level of 80%, and on leaving the heat exchanger 30 it has a temperature of 2° C. and a relative humidity level of 46%;

at the outlet from the heat exchanger 30, the gas stream for treatment has a temperature of 7° C. and a relative humidity level of 100%, with droplets of water in suspension in the gas stream;

at the outlet from the droplet separator 40 and at the inlet of the mixer 50, the gas stream for treatment has a temperature of 7° C. and a relative humidity level of 100%, but without water droplets;

in the inlet pipe 11, the gas stream for treatment has a temperature of 8° C. and a relative humidity level of 93%.

Also, because of the dilution present in the embodiment described, the fan 60 is arranged to deliver a flow rate of 3000 cubic meters (m³) per hour while the flow rate of the gas stream for treatment at the inlet to the cooling enclosure 23 is 1500 m³ per hour and the flow rate of the cooling stream at the inlet to the heat exchanger 30 is 1500 m³ per hour.

Naturally, all of these numerical values are given solely by way of example. The values that it is desirable to obtain in practice depend on operating conditions, and in particular on the nature of the adsorbent mass 17, on the temperature of the outside air, on the temperature and the relative humidity level of the gas stream for treatment at the inlet to the installation, . . . .

Naturally, the invention is not limited to the embodiment described, but covers any variant coming within the ambit of the invention as defined by the claims.

In particular, the installation may be of a structure different from that described. Thus, in the present specification, when it is stated that two elements are connected to each other, they may be connected to each other either directly, or else indirectly via at least one third element.

The double wall may also extend over the top face and/or the bottom face of the vessel.

The fan 60 may be omitted.

It is possible to connect a heater to the inlet pipe 11 of the vessel 10 in order to heat the gas stream for treatment. The heater may include electrical resistor elements or any other heater means. The heater may comprise a first heat exchange circuit that is arranged beside the inlet of the vessel to heat the gas stream and that is connected to a second heat exchange circuit arranged beside the outlet of the peripheral enclosure in order to cool the gas stream for treatment, the first and second heat exchange circuits being arranged on opposite sides of a droplet separator. Thus, in order to lower the temperature of the gas stream for treatment at the outlet from the peripheral enclosure 23, it is possible to use a refrigerator machine or a heat pump with a heat-conveying fluid circuit including an expansion zone at the outlet from the peripheral enclosure 23 and in heat exchange with a pipe for the gas stream for treatment and upstream from the inlet pipe 11.

The installation need not include a mixer.

The fan may be located at a location other than at the inlet to the vessel 10, e.g. such as the inlet to the enclosure 23.

The adsorbent mass may comprise activated carbon and/or other adsorbents such as zeolites and/or alumina. It should be observed that the activated carbons may be impregnated with reagents to improve the efficiency (e.g. KOH, H₃PO₄, . . . , etc.) as a function of the gas is for treatment.

The term “vessel” is used to mean a container suitable for containing activated carbon or any other adsorbent.

In a variant, provision may be made for the fan 60 and the valve 33 to be connected to an electronic control unit that controls the fan 60 and of the valve 33 so as to obtain the expected temperatures and humidity levels.

In another variant, the inlet pipe 11 and the inlet pipe 21 are both provided with respective temperature probes for measuring the temperature of the gas stream for treatment. The enclosure 23 may be provided with a pressure probe. These probes are connected to the electronic control unit so that it can control the installation in real time as a function of measurements provided by the probes.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An installation for treating a gas stream, the installation comprising:
a vessel having an inlet for the gas stream for treatment so as to provide a treated gas stream; and
an outlet for the treated gas stream; and
an adsorbent mass,
wherein the vessel is bounded by a double wall defining a peripheral enclosure that surrounds the vessel and that comprises an enclosure inlet and an enclosure outlet for the gas stream for treatment, the enclosure outlet being connected to the inlet of the vessel.

2. The installation of claim 1, wherein the enclosure outlet is connected to a heat exchanger that has a heat exchanger outlet connected to a droplet separator and that is subjected to a cooling stream having a temperature lower than a temperature of the gas stream for treatment entering the heat exchanger so as to cool the gas stream for treatment and load the gas stream for treatment with water.

3. The installation of claim 2, wherein the heat exchanger has a purge orifice configured to discharge water generated by condensation in the cooling stream.

4. The installation of claim 2, wherein the heat exchanger is connected to a mixer connected between the inlet of the vessel and the droplet separator to mix at least a portion of the cooling stream leaving the heat exchanger with the gas stream for treatment leaving the droplet separator.

5. The installation of claim 1, further comprising:
a heater configured to desaturate the gas stream for treatment, the heater being connected between the inlet of the vessel and the enclosure outlet.

6. The installation of claim 5, wherein the heater comprises a first heat exchange circuit that is arranged beside the inlet of the vessel to heat the gas stream and that is connected to a second heat exchange circuit arranged beside the enclosure outlet in order to cool the gas stream for treatment, the first and second heat exchange circuits being arranged on either side of a droplet separator.

7. The installation of claim 5, wherein the heater is adjustable to bring the gas stream for treatment entering the vessel to a temperature lower than a temperature of the gas stream at the enclosure inlet.

8. The installation of claim 1, further comprising:
a fan configured to force the gas stream for treatment to flow through the installation.

9. The installation of claim 1, wherein the peripheral enclosure includes a purge orifice configured to discharge water generated by condensation on a surface of the peripheral enclosure.
